(19) United States
(12) Patent Application Publication
(10) Pub. No.: US 2010/0021771 A1
(43) Pub. Date: Jan. 28, 2010

(54) METHOD OF MANUFACTURING HEXAGONAL FERRITE MAGNETIC POWDER, MAGNETIC RECORDING MEDIUM AND METHOD OF MANUFACTURING THE SAME

(75) Inventors: Nobuo YAMAZAKI, Kanagawa (JP); Toshio Tada, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 12/506,338

(22) Filed: Jul. 21, 2009

(30) Foreign Application Priority Data
Jul. 23, 2008 (JP) 2008-189410

(51) Int. Cl. G11B 5/706; B05D 5/12; C01G 49/02

(52) U.S. Cl. 428/842.8; 427/128; 423/594.2

(57) ABSTRACT

An aspect of the present invention relates to a method of manufacturing a hexagonal ferrite magnetic powder comprising preparing a melt by melting a starting material mixture, wherein the starting material mixture comprises at least one hexagonal ferrite-forming component and glass-forming component comprising at least one B₂O₃ component and a content of the B₂O₃ component in the mixture ranges from 15 to 27 mole percent in terms of B₂O₃; rapidly cooling the melt to obtain a solid having a saturation magnetization level of equal to or lower than 0.6 A·m²/kg; and heating the solid to a temperature range of 600 to 690° C. and maintaining the solid within the temperature range to precipitate a hexagonal ferrite magnetic powder having an average plate diameter ranging from 15 to 25 nm.

### CROSS-REFERENCE TO RELATED APPLICATIONS

This application claims the benefit of priority under 35 USC 119 to Japanese Patent Application No. 2008-189410, filed on Jul. 23, 2008, which is expressly incorporated herein by reference in its entirety.

### BACKGROUND OF THE INVENTION

1. Field of the Invention

The present invention relates to a method of manufacturing a hexagonal ferrite magnetic powder, and more particularly, to a method of manufacturing a hexagonal ferrite magnetic powder that is suitable as the magnetic powder of a magnetic recording medium having a thin magnetic layer.

The present invention further relates to a magnetic recording medium employing the hexagonal ferrite magnetic powder obtained by the above manufacturing method, and to a method of manufacturing the same.

2. Discussion of the Background

Recently, ferromagnetic metal powders have come to be primarily employed in the magnetic layers of magnetic recording media for high-density recording. Ferromagnetic metal powders are comprised of acicular particles of mainly iron, and are employed in magnetic recording media for various applications in which minute particle size and high coercivity are required for high-density recording.

With the increase in the quantity of information being recorded, magnetic recording media are required to achieve ever higher recording densities. However, in improving the ferromagnetic metal powder to achieve higher density recording, limits have begun to appear. By contrast, hexagonal ferrite magnetic powders have a coercivity that is high enough for use in permanently magnetic materials. Magnetic anisotropy, which is the basis of coercivity, derives from a crystalline structure. Thus, high coercivity can be maintained even when the particle size is reduced. Further, magnetic recording media employing hexagonal ferrite magnetic powder in the magnetic layers thereof can afford good high-density characteristics due to their vertical components. Thus, hexagonal ferrite magnetic powder is an optimal ferromagnetic material for achieving high density.

For example, Japanese Unexamined Patent Publication (KOKAI) Showa No. 56-134522 or English language family member U.S. Pat. No. 4,341,648, Japanese Unexamined Patent Publication (KOKAI) Showa No. 61-10210, Japanese Examined Patent Publication (KOKOKU) Heisei No. 2-39844 or English language family member U.S. Pat. No. 4,543,198, Japanese Unexamined Patent Publication (KOKAI) Heisei Nos. 2-288206 and 3-78211, Japanese Examined Patent Publication (KOKOKU) Heisei No. 4-30086 or English language family member U.S. Pat. No. 4,690,768, Japanese Unexamined Patent Publication (KOKAI) Heisei Nos. 5-12842 and 7-201574 propose manufacturing the hexagonal ferrite magnetic powders used in magnetic recording by the glass crystallization method. The contents of the above applications are expressly incorporated herein by reference in their entirety. In addition to the glass crystallization method as a method of manufacturing hexagonal ferrite powder, other known methods include the water heating synthesis method and the coprecipitation method. However, the glass crystallization method is superior from the perspectives of suitability of the microparticles, suitability of the dispersion of single particles, sharp particle size distribution, and the like, which are desirable for use in magnetic recording media.

The density of recording has continued to increase in recent years. Recording densities of equal to or greater than 1 Gbpsi are now being targeted. Under such conditions, it has become difficult to provide hexagonal ferrite magnetic powders capable of achieving the targeted recording densities with glass crystallization methods, including the methods described in the above applications.

### SUMMARY OF THE INVENTION

An aspect of the present invention provides for a hexagonal ferrite magnetic powder permitting ultra-high-density recording, and a magnetic recording medium suited to high-density recording, in which the hexagonal ferrite magnetic powder is employed.

Reduction of the particle size of hexagonal ferrite magnetic powder is required for reducing noise and increasing the fill rate of the magnetic layer to achieve high-density recording. However, even when the average plate diameter of hexagonal ferrite powder is reduced, when the particle size distribution is broad, components on the microparticle side of the particle size distribution are affected by thermal fluctuation, the recorded magnetic energy cannot overcome thermal energy, and there is a possibility that recording will be lost. Thus, in addition to reducing particle size, it is required to achieve a sharp particle size distribution.

Generally, in the glass crystallization method, components yielding compositions of BaO.6Fe₂O₃ and BaO.B₂O₃ are melted and cooled rapidly to form an amorphous material. When the amorphous material is then heated in the atmosphere, it assumes a state intermediate between solid and liquid at about 500 to 600° C. When the elements in the amorphous material are able to move about, BaO.6Fe₂O₃ begins to crystallize, forming nuclear particles. Normally, at the temperature of equal to or lower than 700° C., all the BaO.6Fe₂O₃ structural component in the amorphous material crystallizes. When further maintained at such temperature in the atmosphere, particles grow. In the particle growing reaction, minute particles melt into the glass substance, becoming starting materials for the growth of other particles. This reaction is thought to be based on the Ostwald ripening reaction. The particles continue to grow when the temperature is raised.

Accordingly, the present inventors reached the conclusion that suppressing the melting—precipitation reaction during nuclear particle growth was important to further improve the particle size distribution. As the result of further research, they discovered the following.

When the melting—precipitation reaction is produced at the point where the BaO.6Fe₂O₃ structural component in an amorphous material begins to crystallize (where uncrystallized component remains) to produce nuclear particles, broadening of the particle size distribution occurs at this point. This is thought to be related to the difference in the reaction rate between the reaction producing nuclear particles by crystallization of the uncrystallized component and the melting—precipitation reaction. For suppressing the melting—precipitation reaction during nuclear particle production, it is effective to reduce the quantity of the glass substance (B₂O₃) melting the nuclear particles and to keep the crystallization temperature low. Even when the glass substance is reduced, it is difficult to suppress the melting—precipitation reaction if the crystallization temperature is high. On the other hand, simply lowering the temperature reduces the rate of the nuclear particle producing reaction. Thus, to obtain hexagonal ferrite magnetic powders with lowering the crystallization temperature, the nuclear particle producing reaction must be conducted for an extended period. However, when the nuclear particle producing reaction is conducted for an extended period, the nucleation and particle growing reaction based on the uncrystallized component progresses simultaneously, causing the particle size distribution to broaden.

Further, the saturation magnetization level of the amorphous material also affects particle size distribution. The saturation magnetization level of the amorphous material obtained by rapidly cooling the starting material mixture is thought to indicate the amorphous property of the starting material mixture. In the glass crystallization method, the starting material mixture is rapidly cooled to render it amorphous. When cooled at a rate exceeding the crystallization rate during this rapid cooling, the obtaining of an amorphous material proceeds smoothly. However, when the cooling rate does not keep up with the crystallization rate, crystal particles end up precipitating during the rapid cooling. The more crystal particles that precipitate during the rapid cooling, the greater the saturation magnetization level of the amorphous material. However, the crystal particles that precipitate out at this stage differ in particle size distribution from the crystal particles that subsequently precipitate during the crystallization step. Thus, the more particles that precipitate out during the rapid cooling, the broader the particle size distribution of the hexagonal ferrite particles that are finally obtained tends to be.

Further, in case that particles that have been produced when all of the BaO.6Fe₂O₃ component in the amorphous material has crystallized are smaller than the target particle size, it is required to continue the reaction for particle growth. However, since this reaction is based on Ostwald ripening, continuing the reaction causes the particle size distribution to broaden. Thus, when the particles reach the target size, the particle size distribution ends up being large. Accordingly, the final target particle size in the crystallization step also affects the particle size distribution.

Based on the above, the present inventors discovered that the above-stated hexagonal ferrite magnetic powder was achieved by: (1) reducing the quantity of B₂O₃ component in the starting material; (2) reducing the saturation magnetization level of the solid obtained by rapidly cooling the melt; (3) lowering the crystallization temperature; and (4) reducing the target particle size. The present invention was devised on that basis.

An aspect of the present invention relates to a method of manufacturing a hexagonal ferrite magnetic powder comprising:

preparing a melt by melting a starting material mixture, wherein the starting material mixture comprises a hexagonal ferrite-forming component and a glass-forming component comprising a B₂O₃ component and a content of the B₂O₃ component in the starting material mixture ranges from 15 to 27 mole percent in terms of B₂O₃;

rapidly cooling the melt to obtain a solid having a saturation magnetization level of equal to or lower than 0.6 A.m²/kg; and

heating the solid to a temperature range of 600 to 690° C. and maintaining the solid within the temperature range to precipitate a hexagonal ferrite magnetic powder having an average plate diameter ranging from 15 to 25 nm.

The starting material mixture may comprise one or more glass-forming component other than the B₂O₃ component, for example, in a quantity ranging from 5 to 40 mole percent on the basis of oxide relative to the content of the B₂O₃ component in terms of B₂O₃.

The glass-forming component may comprise one or more SiO₂ component.

The hexagonal ferrite magnetic powder may be a barium ferrite magnetic powder.

The hexagonal ferrite magnetic powder may have a coefficient of variation in particle diameter distribution of equal to or lower than 25 percent.

A further aspect of the present invention relates to a magnetic recording medium comprising a magnetic layer on a nonmagnetic support, wherein the magnetic layer comprises a hexagonal ferrite magnetic powder obtained by the above method and a binder.

A still further aspect of the present invention relates to a method of manufacturing a magnetic recording medium comprising:

manufacturing a hexagonal ferrite magnetic power by the above method; and

forming a magnetic layer with the manufactured hexagonal ferrite magnetic power.

The magnetic layer may have a thickness of equal to or less than 80 nm.

The present invention can provide a magnetic recording medium permitting ultra-high-density recording.

### DETAILED DESCRIPTION OF THE EMBODIMENTS

Unless otherwise stated, a reference to a compound or component includes the compound or component by itself, as well as in combination with other compounds or components, such as mixtures of compounds.

As used herein, the singular forms “a,” “an,” and “the” include the plural reference unless the context clearly dictates otherwise.

Except where otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, and not to be considered as an attempt to limit the application of the doctrine of equivalents to the scope of the claims, each numerical parameter should be construed in light of the number of significant digits and ordinary rounding conventions.

Additionally, the recitation of numerical ranges within this specification is considered to be a disclosure of all numerical values and ranges within that range. For example, if a range is from about 1 to about 50, it is deemed to include, for example, 1, 7, 34, 46.1, 23.7, or any other value or range within the range.

The following preferred specific embodiments are, therefore, to be construed as merely illustrative, and non-limiting to the remainder of the disclosure in any way whatsoever. In this regard, no attempt is made to show structural details of the present invention in more detail than is necessary for fundamental understanding of the present invention; the description taken with the drawings making apparent to those skilled in the art how several forms of the present invention may be embodied in practice.

### Method of Manufacturing Hexagonal Ferrite Magnetic Powder

The method of manufacturing a hexagonal ferrite magnetic powder of the present invention manufactures a hexagonal ferrite magnetic powder by the glass crystallization method and comprises the following steps:

(1) preparing a melt by melting a starting material mixture, wherein the starting material mixture comprises a hexagonal ferrite-forming component and a glass-forming component comprising a B₂O₃ component and a content of the B₂O₃ component in the starting material mixture ranges from 15 to 27 mole percent in terms of B₂O₃;

(2) rapidly cooling the melt to obtain a solid having a saturation magnetization level of equal to or lower than 0.6 A·m²/kg (approximately equal to or lower than 0.6 emu/g); and

(3) heating the solid to a temperature range of 600 to 690° C. and maintaining the solid within the temperature range to precipitate a hexagonal ferrite magnetic powder having an average plate diameter ranging from 15 to 25 nm.

The method of manufacturing a hexagonal ferrite magnetic powder of the present invention will be described in further detail below.

### Starting Material Mixture

The starting material mixture employed in the present invention comprises at least one glass-forming component and hexagonal ferrite-forming component. Glass-forming components are components that exhibit a glass transition phenomenon and become amorphous (vitrify). In common glass crystallization methods, a B₂O₃ component is employed as a glass-forming component. In the present invention, as well, a glass starting material mixture comprising a glass-forming component in the form of a B₂O₃ component is employed. The content thereof is kept to equal to or lower than 27 mole percent in terms of B₂O₃ (oxide conversion) to suppress the melting—precipitation reaction during nuclear particle growth for achieving a sharp particle size distribution. However, at less than 15 mole percent, the melting—precipitation reaction is suppressed excessively, making it difficult to obtain hexagonal ferrite magnetic powder of desired particle size. Thus, the lower limit is set at 15 mole percent. That is, the quantity of the B₂O₃ component in the starting material mixture is 15 to 27 percent in terms of B₂O₃ (oxide conversion), desirably 15 to 25 percent.

In the glass crystallization method, the various components contained in the starting material mixture are present in the form of oxides, or in the form of various salts that can be converted to oxides in steps such as the melting step. In the present invention, the term “B₂O₃ component” refers to B₂O₃ itself, as well as various salts such as H₂BO₃ that can be converted to B₂O₃ in processing steps. The same holds true for other components.

As set forth above, hexagonal ferrite magnetic powders with a sharp particle size distribution can be obtained by reducing the quantity of the B₂O₃ component. However, the B₂O₃ component is a component that can promote the melting of BaO component and Fe₂O₃ component, which are commonly employed as hexagonal ferrite-forming components. Thus, reducing the quantity of the B₂O₃ component may tend to preclude melting of the starting material mixture. Reducing the quantity of the B₂O₃ component may increase the relative proportion of hexagonal ferrite component, sometimes compromising the formation of an amorphous material. The present inventors discovered that in such cases, the addition of glass-forming components other than the B₂O₃ component to the starting material mixture could mitigate the above phenomena. The glass-forming components other than B₂O₃ desirably have a glass transition temperature higher than that of B₂O₃. This is because it is difficult to suppress the melting—precipitation reaction with components having a lower glass transition temperature than B₂O₃. Examples of the above components are SiO₂ component and GeO₂ component.

When employing a B₂O₃ component with other glass-forming components, the starting material mixture desirably comprises the glass-forming components other than the B₂O₃ component in a quantity of equal to or lower than 40 mole percent, on the basis of oxide, relative to the content of the B₂O₃ component in terms of B₂O₃. When this quantity is equal to or lower than 40 mole percent relative to the B₂O₃ component, it is possible to avoid having large quantities of glass-forming components (such as SiO₂) remain in the hexagonal ferrite magnetic powder that is the final product, resulting in poor dispersion and a low magnetic powder fill rate when employed in a magnetic recording medium, and compromising electromagnetic characteristics. However, the effect achieved by addition of the glass-forming components other than the B₂O₃ component may be small at quantities of less than 5 mole percent. Thus, when adding these components, the quantity added is desirably equal to or greater than 5 mole percent on the basis of oxide relative to the content of the B₂O₃ component in terms of B₂O₃. The quantity of these other glass-forming components is preferably 10 to 30 mole percent on the basis of oxide relative to the content of the B₂O₃ component in terms of B₂O₃.

Examples of hexagonal ferrite-forming components contained in the starting material mixture are metal oxides such as Fe₂O₃, BaO, SrO, and PbO, which are components that become constituent components of hexagonal ferrite magnetic powder. For example, the use of BaO as the principal hexagonal ferrite-forming component makes it possible to obtain a barium ferrite magnetic powder. The quantity of the hexagonal ferrite-forming component in the starting material mixture can be suitably set based on the desired magnetic characteristics.

It is also possible to obtain a hexagonal ferrite magnetic powder in which a portion of the Fe is replaced with another metal element to adjust the coercivity. Examples of replacement elements are: Co—Zn—Nb, Co—Ti, Co—Ti—Sn, Co—Sn—Nb, Co—Zn—Sn—Nb, Co—Zn—Zr—Nb, and Co—Zn—Mn—Nb. To obtain such hexagonal ferrite magnetic powders, it suffices to employ a coercivity-adjusting component as a hexagonal ferrite-forming component. Examples of coercivity-adjusting components are divalent metal oxide components such as CoO, NiO, and ZnO, and tetravalent metal oxide components such as TiO₂, ZrO₂, and HfO₂. When employing such a coercivity-adjusting component, the content thereof can be suitably determined in accordance with the desired coercivity and the like.

The above starting material mixture can be obtained by weighing out and mixing the various components.

### Melting the Starting Material Mixture and Solidifying the Melt

In the present invention, the starting material mixture is melted to obtain a melt. The melting temperature can be set based on the starting material composition, for example, to 1,000 to 1,500° C. The melting time can be suitably set for suitable melting of the starting material mixture.

Next, the melt that is obtained is rapidly cooled to obtain a solid. The solid contains amorphous material in the form of glass-forming components that have been rendered amorphous (vitrified). The rapid cooling can be carried out in the same manner as in the rapid cooling step commonly employed to obtain an amorphous material in glass crystallization methods. For example, a known method can be conducted, such as a rapid cooling rolling method in which the melt is poured onto a pair of water-cooled rollers being rotated at high speed.

In the present invention, the above rapid cooling yields a solid with a saturation magnetization level of equal to or lower than 0.6 A·m²/kg. As set forth above, the saturation magnetization level of the solid obtained following rapid cooling can be an indicator of the quantity of crystals precipitating during rapid cooling. A solid with a saturation magnetization level exceeding 0.6 A·m²/kg contains a large amount of precipitated crystals in the amorphous material. These precipitated crystals cause the particle size distribution of the hexagonal ferrite that is finally obtained to broaden, making it difficult to obtain hexagonal ferrite magnetic powders having a sharp particle size distribution. The lower limit of the saturation magnetization level is, for example, equal to or higher than 0.2 A·m²/kg. However, a solid having a saturation magnetization level of less than 0.2 A·m²/kg can also be obtained.

The saturation magnetization level of the solid can be controlled by the cooling rate during the rapid cooling. The saturation magnetization level of the above solid is determined by the balance between the crystallization rate and the cooling rate. Since the crystallization rate can vary with the starting material composition, the cooling rate during the rapid cooling can be set based on the starting material composition. The cooling rate can be controlled by the thermal conductivity of the cooling rollers, peripheral speed of the rollers, pressure between rollers, quantity of melt dripping onto the rollers, and the like. Such control makes it possible to keep the saturation magnetization level of the solid within a desired range.

### Heat Treating the Solid

Following the above rapid cooling, the solid obtained is subjected to a heat treatment. This step can cause the hexagonal ferrite particles to crystallize, precipitating out in the amorphous phase (glass phase). In the present invention, this heat treatment is conducted by heating to a temperature range of 600 to 690° C. the solid obtained by rapid cooling, and maintaining it within this temperature range until the average plate diameter of the precipitating hexagonal ferrite magnetic powders reaches 15 to 25 nm. When attempting to cause hexagonal ferrite magnetic powders with an average plate diameter exceeding 25 nm to precipitate, as set forth above, it is necessary to continue the crystallization reaction, and a broad particle size distribution results when the targeted particle size is reached. However, when the particle size of the hexagonal ferrite magnetic powder being precipitated is excessively small, despite a sharp particle size distribution, it is impossible to obtain hexagonal ferrite magnetic powder having a coercivity Hc that is suited to magnetic recording media. Accordingly, in the present invention, the average plate diameter of the hexagonal ferrite magnetic powder that is precipitated is set at 15 to 25 nm. The average plate diameter is desirably 15 to 20 nm. The average plate diameter is the average value of the plate diameter as measured by randomly extracting 500 particles in a photograph taken by a transmission electron microscope. The particle size of hexagonal ferrite magnetic powder essentially does not change in the coarse pulverization or magnetic layer coating liquid preparation step as conducted in Examples described further below. Thus, the average plate diameter measured after the step of manufacturing hexagonal ferrite magnetic powder and the average plate diameter measured in the magnetic layer can be adopted as the average plate diameter of the hexagonal ferrite magnetic powder precipitated by the above heat treatment. The same applies to the particle size distribution described further below.

In the present invention, the heat treatment of the solid is conducted at a temperature range of 600 to 690° C. When the heating temperature is less than 600° C., the crystallization reaction does not progress adequately, making it difficult to obtain hexagonal ferrite magnetic powder of desired particle size. Conversely, when the heating temperature exceeds 690° C., as set forth above, it becomes difficult to obtain hexagonal ferrite magnetic powders of sharp particle size distribution due to the melting—precipitation reaction during nuclear particle growth. The heating temperature is desirably 620 to 680° C. The particle size of the hexagonal ferrite magnetic powder that is precipitated can be controlled by means of the heating temperature and the heating period. In the present invention, a suitable heating temperature is desirably selected based on the targeted particle size within a range of 600 to 690° C., desirably within a range of 620 to 680° C. The rate of rise in temperature up to the temperature range is suitably about 10 to 500° C./minute, for example. The period of maintenance within the above temperature range is, for example, 2 to 12 hours, desirably 3 to 6 hours.

The product of the above heat treatment will normally comprise hexagonal ferrite magnetic powders and an amorphous phase. Various processes generally employed in glass crystallization methods, such as acid treatment with heating, can be employed to remove the amorphous phase to obtain hexagonal ferrite magnetic powders. The particles from which the excess glass component has been removed by this treatment can be subjected as needed to post-processing, such as washing with water and drying, to obtain hexagonal ferrite magnetic powders that are suitable for use in magnetic recording media.

According to the present invention, it is possible to obtain hexagonal ferrite magnetic powders with a sharp particle size distribution through the above steps. The particle size distribution of the hexagonal ferrite magnetic powders obtained can be evaluated by, for example, randomly selecting 500 particles in a photograph taken by a transmission electron microscope, calculating the average value of the plate diameters (average plate diameter) measured, calculating the standard deviation of the plate diameter of the 500 particles, and dividing it by the average plate diameter, to obtain the coefficient of variation in the particle diameter distribution. According to the present invention, it is possible to obtain hexagonal ferrite magnetic powders exhibiting a particle size distribution in the form of a coefficient of variation in particle diameter distribution of equal to or lower than 25 percent, for example, 15 to 25 percent. Hexagonal ferrite magnetic powders with a broad particle size distribution contain a large number of particles far removed from the average plate diameter. The average plate diameter of the hexagonal ferrite magnetic powder obtained by the present invention ranges from 15 to 25 nm, as stated above. Particles smaller than this range may not contribute to magnetic characteristics, and thus may act as nonmagnetic particles. Large particles exceeding this range may become a source of noise. When the particle size distribution is broad, numerous particles that either do not contribute to magnetic characteristics or compromise magnetic characteristics are present. By contrast, the present invention can permit the obtaining of hexagonal ferrite magnetic powders having good magnetic characteristics with a sharp particle size distribution. According to the present invention, it is possible to obtain a hexagonal ferrite magnetic powder having a coercivity suited to magnetic recording, such as a coercivity of equal to or greater than 173 kA/m, or even 173 to 340 kA/m.

### Magnetic Recording Medium and Method of the Same

The magnetic recording medium of the present invention comprises, on a nonmagnetic support, a magnetic layer comprising a hexagonal ferrite magnetic powder obtained by the manufacturing method of the present invention and a binder.

The method of manufacturing a magnetic recording medium of the present invention comprises manufacturing a hexagonal ferrite magnetic power by the manufacturing method of the present invention and forming a magnetic layer with the manufactured hexagonal ferrite magnetic power.

The magnetic recording medium of the present invention and the method of manufacturing a magnetic recording medium of the present invention will be described in further detail below.

### Magnetic Layer

Details of the hexagonal ferrite magnetic powder employed in the magnetic layer, and the method of manufacturing the powder, are as set forth above. In addition to hexagonal ferrite magnetic powder, the magnetic layer comprises a binder. Examples of the binder comprised in the magnetic layer are: polyurethane resins; polyester resins; polyamide resins; vinyl chloride resins; styrene; acrylonitrile; methyl methacrylate and other copolymerized acrylic resins; nitrocellulose and other cellulose resins; epoxy resins; phenoxy resins; and polyvinyl acetal, polyvinyl butyral, and other polyvinyl alkyral resins. These may be employed singly or in combinations of two or more. Of these, the desirable binders are the polyurethane resins, acrylic resins, cellulose resins, and vinyl chloride resins. These resins may also be employed as binders in the nonmagnetic layer described further below. A polyisocyanate curing agent may also be employed with the above resins.

To enhance the dispersibility of ferromagnetic powder and nonmagnetic powder in the above binder, the binder desirably comprises functional groups (polar groups) adsorbing to the surface of these powders. Examples of desirable functional groups are: —SO₃M, —SO₄M, —PO(OM)₂, —OPO(OM)₂, —COOM, ═NSO₃M, ═NRSO₃M, —NR¹R², and —N+R¹R²R³X⁻. In the above, M denotes hydrogen or an alkali metal such as Na or K; R denotes an alkylene group; R¹, R², and R³ denote alkyl groups, hydroxyalkyl groups, or hydrogen; and X denotes a halogen such as Cl or Br. The quantity of functional groups in the binder is desirably equal to or higher than 10 μeq/g and equal to or lower than 200 μeq/g, preferably equal to or higher than 30 μeq/g and equal to or lower than 120 μeq/g. The quantity of functional groups desirably falls within the above range because good dispersibility can be achieved therein.

The molecular weight of the binder is desirably a weight average molecular weight of equal to or greater than 10,000 and equal to or lower than 200,000. The molecular weight desirably falls within the above range because adequate coating strength and good durability can be obtained and dispersibility can be increased.

The binder can be employed in a range of, for example, 5 to 50 weight percent, desirably 10 to 30 weight percent, of the nonmagnetic powder in the nonmagnetic layer or of the magnetic powder in the magnetic layer.

As needed, additives can be added to the magnetic layer. Examples of additives are: abrasives, lubricants, dispersing agents, dispersion adjuvants, antifungal agents, antistatic agents, oxidation inhibitors, solvents, and carbon black. These additives may be employed in the form of a commercial product suitably selected based on desired properties.

Examples of types of carbon black that are suitable for use in the magnetic layer are: furnace black for rubber, thermal for rubber, black for coloring, and acetylene black. It is preferable that the specific surface area is 5 to 500 m²/g, the DBP oil absorption capacity is 10 to 400 ml/100 g, the particle diameter is 5 to 300 nm, the pH is 2 to 10, the moisture content is 0.1 to 10 percent, and the tap density is 0.1 to 1 g/ml. When employing carbon black, the quantity preferably ranges from 0.1 to 30 weight percent with respect to the weight of the ferromagnetic powder. For example, the Carbon Black Handbook compiled by the Carbon Black Association, which is expressly incorporated herein by reference in its entirety, may be consulted for types of carbon black suitable for use in the present invention. Commercially available carbon black can be employed.

As needed, the types and quantities of additives employed in the magnetic layer may differ from those employed in the nonmagnetic layer, described further below, in the present invention. All or some part of the additives employed in the present invention can be added in any of the steps during the manufacturing of coating liquids for the magnetic layer and nonmagnetic layer. For example, there are cases where they are mixed with the magnetic powder prior to the kneading step; cases where they are added during the step in which the magnetic powder, binder, and solvent are kneaded; cases where they are added during the dispersion step; cases where they are added after dispersion; and cases where they are added just before coating. When dispersing the hexagonal ferrite magnetic powder, the particle surface of the magnetic powder can be processed with a substance suited to a dispersion medium and a polymer. Both organic and inorganic compounds can be employed as surface treatment agents. Examples of the principal compounds are oxides and hydroxides of Si, Al, P, and the like; various silane coupling agents; and various titanium coupling agents. The quantity of surface treatment agent added normally range from 0.1 to 10 weight percent relative to the weight of the magnetic powder. The pH of the magnetic powder normally ranges from about 4 to 12, and is usually optimum for the dispersion medium and polymer. From the perspective of the chemical stability and storage properties of the medium, a pH of about 6 to 10 is usually selected. As for moisture contained in the magnetic powder, there is an optimum level for the dispersion medium and polymer, usually selected from the range of 0.01 to 2.0 weight percent.

### Nonmagnetic Layer

Details of the nonmagnetic layer will be described below. The magnetic recording medium of the present invention may comprise a nonmagnetic layer comprising a nonmagnetic powder and a binder between the nonmagnetic support and the magnetic layer. Both organic and inorganic substances may be employed as the nonmagnetic powder in the nonmagnetic layer. Carbon black may also be employed. Examples of inorganic substances are metals, metal oxides, metal carbonates, metal sulfates, metal nitrides, metal carbides, and metal sulfides. These nonmagnetic powders are commercially available and can be manufactured by the known methods.

Specifically, titanium oxides such as titanium dioxide, cerium oxide, tin oxide, tungsten oxide, ZnO, ZrO₂, SiO₂, Cr₂O₃, α-alumina with an α-conversion rate of 90 to 100 percent, β-alumina, γ-alumina, α-iron oxide, goethite, corundum, silicon nitride, titanium carbide, magnesium oxide, boron nitride, molybdenum disulfide, copper oxide, MgCO₃, CaCO₃, BaCO₃, SrCO₃, BaSO₄, silicon carbide, and titanium carbide may be employed singly or in combinations of two or more. α-iron oxide and titanium oxide are preferred.

The nonmagnetic powder may be acicular, spherical, polyhedral, or plate-shaped. The crystallite size of the nonmagnetic powder preferably ranges from 4 nm to 500 nm, more preferably from 40 to 100 nm. A crystallite size falling within a range of 4 nm to 500 nm is desirable in that it facilitates dispersion and imparts a suitable surface roughness. The average particle diameter of the nonmagnetic powder preferably ranges from 5 nm to 500 nm. As needed, nonmagnetic powders of differing average particle diameter may be combined; the same effect may be achieved by broadening the average particle distribution of a single nonmagnetic powder. The particularly preferred average particle diameter of the nonmagnetic powder ranges from 10 to 200 nm. Within a range of 5 nm to 500 nm, dispersion can be good and a nonmagnetic layer with suitable surface roughness can be achieved; the above range is preferred.

The specific surface area of the nonmagnetic powder preferably ranges from 1 to 150 m²/g, more preferably from 20 to 120 m²/g, and further preferably from 50 to 100 m²/g. Within the specific surface area ranging from 1 to 150 m²/g, a nonmagnetic layer with suitable surface roughness can be achieved and dispersion of the nonmagnetic powder is possible with the suitable quantity of binder; the above range is preferred. Oil absorption capacity using dibutyl phthalate (DBP) of the nonmagnetic powder preferably ranges from 5 to 100 mL/100 g, more preferably from 10 to 80 mL/100 g, and further preferably from 20 to 60 mL/100 g. The specific gravity ranges from, for example, 1 to 12, preferably from 3 to 6. The tap density ranges from, for example, 0.05 to 2 g/mL, preferably from 0.2 to 1.5 g/mL. A tap density falling within a range of 0.05 to 2 g/mL can reduce the amount of scattering particles, thereby facilitating handling, and tends to prevent solidification to the device. The pH of the nonmagnetic powder preferably ranges from 2 to 11, more preferably from 6 to 9. When the pH falls within a range of 2 to 11, increase of the coefficient of friction at high temperature or high humidity or due to the freeing of fatty acids can be prevented. The moisture content of the nonmagnetic powder preferably ranges from 0.1 to 5 weight percent, more preferably from 0.2 to 3 weight percent, and further preferably from 0.3 to 1.5 weight percent. A moisture content falling within a range of 0.1 to 5 weight percent is desirable because it can produce good dispersion and yield a stable coating viscosity following dispersion. An ignition loss of equal to or less than 20 weight percent is desirable and nonmagnetic powders with low ignition losses are desirable.

When the nonmagnetic powder is an inorganic powder, the Mohs' hardness is preferably 4 to 10. Durability can be ensured if the Mohs' hardness ranges from 4 to 10. The stearic acid (SA) adsorption capacity of the nonmagnetic powder preferably ranges from 1 to 20 μmol/m², more preferably from 2 to 15 μmol/m². The heat of wetting in 25° C. water of the nonmagnetic powder is preferably within a range of 200 to 600 erg/cm² (200 to 600 mJ/m²). A solvent with a heat of wetting within this range may also be employed. The quantity of water molecules on the surface at 100 to 400° C. suitably ranges from 1 to 10 pieces per 100 Angstroms. The pH of the isoelectric point in water preferably ranges from 3 to 9. The surface of these nonmagnetic powders preferably contains Al₂O₃, SiO₂, TiO₂, ZrO₂, SnO₂, Sb₂O₃, and ZnO by conducting surface treatment. The surface-treating agents of preference with regard to dispersibility are Al₂O₃, SiO₂, TiO₂, and ZrO₂, and Al₂O₃, SiO₂ and ZrO₂ are further preferable. They may be employed singly or in combination. Depending on the objective, a surface-treatment coating layer with a coprecipitated material may also be employed, the method which comprises a first alumina coating and a second silica coating thereover or the reverse method thereof may also be adopted. Depending on the objective, the surface-treatment coating layer may be a porous layer, with homogeneity and density being generally desirable.

Carbon black may be combined with nonmagnetic powder in the nonmagnetic layer to reduce surface resistivity, reduce light transmittance, and adjust hardness. For example, furnace black for rubber, thermal black for rubber, black for coloring, acetylene black and the like may be employed in the nonmagnetic layer.

The specific surface area of the carbon black employed in the nonmagnetic layer is, for example, 100 to 500 m²/g, preferably 150 to 400 m²/g. The DBP oil absorption capability is, for example, 20 to 400 mL/100 g, preferably 30 to 200 mL/100 g. The particle diameter of the carbon black is, for example, 5 to 80 nm, preferably 10 to 50 nm, and more preferably, 10 to 40 nm. It is preferable that the pH of the carbon black is 2 to 10, the moisture content is 0.1 to 10 percent, and the tap density is 0.1 to 1 g/mL. The carbon black employed may be surface-treated with a dispersant or grafted with resin, or have a partially graphite-treated surface. The carbon black may be dispersed in advance into the binder prior to addition to the coating liquid. The quantity of the carbon black is preferably within a range not exceeding 50 weight percent of the nonmagnetic powder as well as not exceeding 40 percent of the total weight of the nonmagnetic layer. These carbon blacks may be used singly or in combination. For example, the Carbon Black Handbook compiled by the Carbon Black Association may be consulted for types of carbon black suitable for use in the nonmagnetic layer. Commercially available carbon black can be employed.

Based on the objective, an organic powder may be added to the nonmagnetic layer. Examples of such an organic powder are acrylic styrene resin powders, benzoguanamine resin powders, melamine resin powders, and phthalocyanine pigments. Polyolefin resin powders, polyester resin powders, polyamide resin powders, polyimide resin powders, and polyfluoroethylene resins may also be employed. The manufacturing methods described in Japanese Unexamined Patent Publication (KOKAI) Showa Nos. 62-18564 and 60-255827 may be employed. The contents of the above applications are expressly incorporated herein by reference in their entirety.

Binder resins, lubricants, dispersing agents, additives, solvents, dispersion methods, and the like suited to the magnetic layer may be adopted to the nonmagnetic layer. In particular, known techniques for the quantity and type of binder resin and the quantity and type of additives and dispersion agents employed in the magnetic layer may be adopted thereto.

An undercoating layer can be provided in the magnetic recording medium of the present invention. Providing an undercoating layer can enhance adhesive strength between the support and the magnetic layer or nonmagnetic layer. For example, a polyester resin that is soluble in solvent can be employed as the undercoating layer.

### Nonmagnetic Support

A known film such as biaxially-oriented polyethylene terephthalate, polyethylene naphthalate, polyamide, polyamidoimide, or aromatic polyamide can be employed as the nonmagnetic support. Of these, polyethylene terephthalate, polyethylene naphthalate, and polyamide are preferred.

These supports can be corona discharge treated, plasma treated, treated to facilitate adhesion, heat treated, or the like in advance. The center average roughness, Ra, at a cutoff value of 0.25 mm of the nonmagnetic support suitable for use in the present invention preferably ranges from 3 to 10 nm.

### Layer Structure

As for the thickness structure of the magnetic recording medium of the present invention, the thickness of the nonmagnetic support preferably ranges from 3 to 80 micrometers. When an undercoating layer is provided between the nonmagnetic support and the nonmagnetic layer or the magnetic layer, the thickness of the undercoating layer ranges from, for example, 0.01 to 0.8 micrometer, preferably 0.02 to 0.6 micrometer.

The magnetic layer is desirably equal to or less than 80 nm in thickness. An S/N enhancing effect due to a sharp particle size distribution can be achieved by employing hexagonal ferrite magnetic powders with a sharp particle size distribution in the magnetic layer. This effect can be particularly pronounced in thin magnetic layers of equal to or less than 80 nm in thickness. This is attributed to the enhancement of effects due to the small content of extremely small particles that do not contribute to recording and the small content of extremely coarse particles thought to affect noise in a thin magnetic layer comprising a small total number of magnetic particles. The magnetic layer preferably has a thickness falling within a range of 30 to 60 nm.

The nonmagnetic layer is, for example, 0.1 to 3.0 micrometers, preferably 0.3 to 2.0 micrometers, and more preferably, 0.5 to 1.5 micrometers in thickness. The nonmagnetic layer of the magnetic recording medium of the present invention can exhibit its effect so long as it is substantially nonmagnetic. It can exhibit the effect of the present invention, and can be deemed to have essentially the same structure as the magnetic recording medium of the present invention, for example, even when impurities are contained or a small quantity of magnetic material is intentionally incorporated. The term “essentially the same” means that the residual magnetic flux density of the nonmagnetic layer is equal to or lower than 10 mT, or the coercivity is equal to or lower than 7.96 kA/m (approximately equal to or lower than 100 Oe), with desirably no residual magnetic flux density or coercivity being present.

### Back Layer

A back layer can be provided on the surface of the nonmagnetic support opposite to the surface on which the magnetic layer and optionally the nonmagnetic layer are provided, in the magnetic recording medium of the present invention. The back layer desirably comprises carbon black and inorganic powder. The formula of the magnetic layer or nonmagnetic layer can be applied to the binder and various additives for the formation of the back layer. The back layer is preferably equal to or less than 0.9 micrometer, more preferably 0.1 to 0.7 micrometer, in thickness.

### Manufacturing Method

The process for manufacturing magnetic layer, nonmagnetic layer and back layer coating liquids normally comprises at least a kneading step, a dispersing step, and a mixing step to be carried out, if necessary, before and/or after the kneading and dispersing steps. Each of the individual steps may be divided into two or more stages. All of the starting materials employed in the present invention, including the hexagonal ferrite magnetic powder, nonmagnetic powder, binders, carbon black, abrasives, antistatic agents, lubricants, solvents, and the like, may be added at the beginning of, or during, any of the steps. Moreover, the individual starting materials may be divided up and added during two or more steps. For example, polyurethane may be divided up and added in the kneading step, the dispersion step, and the mixing step for viscosity adjustment after dispersion. To achieve the object of the present invention, conventionally known manufacturing techniques may be utilized for some of the steps. A kneader having a strong kneading force, such as an open kneader, continuous kneader, pressure kneader, or extruder is preferably employed in the kneading step. Details of the kneading process are described in Japanese Unexamined Patent Publication (KOKAI) Heisei Nos. 1-106338 and 1-79274. The contents of these applications are incorporated herein by reference in their entirety. Further, glass beads may be employed to disperse the magnetic layer, nonmagnetic layer and back layer coating liquids, with a dispersing medium with a high specific gravity such as zirconia beads, titania beads, and steel beads being suitable for use as the glass beads. The particle diameter and fill ratio of these dispersing media can be optimized for use. A known dispersing device may be employed.

In the method for manufacturing a magnetic recording medium, for example, a nonmagnetic layer coating liquid is coated to yield a prescribed film thickness on the surface of a running nonmagnetic support, thereby forming a nonmagnetic layer, and a magnetic layer coating liquid is then coated to yield a prescribed film thickness thereover, forming a magnetic layer. Multiple magnetic layer coating liquids may be successively or simultaneously coated in a multilayer coating, or a nonmagnetic layer coating liquid and magnetic layer coating liquid can be successively or simultaneously coated in a multilayer coating. Coating machines suitable for use in coating the magnetic layer and nonmagnetic layer coating liquids are air doctor coaters, blade coaters, rod coaters, extrusion coaters, air knife coaters, squeeze coaters, immersion coaters, reverse roll coaters, transfer roll coaters, gravure coaters, kiss coaters, cast coaters, spray coaters, spin coaters, and the like. For example, “Recent Coating Techniques” (May 31, 1983), issued by the Sogo Gijutsu Center K.K. may be referred to in this regard. The content of the above publication is expressly incorporated herein by reference in its entirety.

When it is a magnetic tape, the coating layer that is formed by applying the magnetic layer coating liquid can be magnetic field orientation processed using cobalt magnets or solenoids on the hexagonal ferrite magnetic powder contained in the coating layer. When it is a disk, an adequately isotropic orientation can be achieved in some products without orientation using an orientation device, but the use of a known random orientation device in which cobalt magnets are alternately arranged diagonally, or alternating fields are applied by solenoids, is desirable. Further, a known method, such as opposing magnets of opposite poles, can be employed to effect perpendicular orientation, thereby imparting an isotropic magnetic characteristic in the peripheral direction. Perpendicular orientation is particularly desirable when conducting high-density recording. Spin coating can be used to effect peripheral orientation.

The drying position of the coating is desirably controlled by controlling the temperature and flow rate of drying air, and coating speed. A coating speed of 20 m/min to 1,000 m/min and a dry air temperature of equal to or higher than 60° C. are desirable. Suitable predrying can be conducted prior to entry into the magnet zone.

The coated stock material thus obtained can be normally temporarily wound on a take-up roll, and then unwound from the take-up roll and calendered.

For example, super calender rolls can be employed in calendering. Calendering can enhance surface smoothness, eliminate voids produced by the removal of solvent during drying, and increase the fill rate of the hexagonal ferrite magnetic powder in the magnetic layer, thus yielding a magnetic recording medium of good electromagnetic characteristics. The calendering step is desirably conducted by varying the calendering conditions based on the smoothness of the surface of the coated stock material.

Rolls of a heat-resistant plastic such as epoxy, polyimide, polyamide, or polyamidoimide, can be employed as the calender rolls. Processing with metal rolls is also possible.

As for the calendering conditions, the calender roll temperature ranges from, for example, 60 to 100° C., preferably 70 to 100° C., and more preferably, 80 to 100° C. The pressure ranges from, for example, 100 to 500 kg/cm (approximately 98 to 490 kN/m), preferably 200 to 450 kg/cm (approximately 196 to 441 kN/m), and more preferably, 300 to 400 kg/cm (approximately 294 to 392 kN/m). Calendering can be conducted on the surface of the nonmagnetic layer, for example, under the above conditions.

The magnetic recording medium obtained can be cut to desired size with a cutter or the like for use. The cutter is not specifically limited, but desirably comprises multiple sets of a rotating upper blade (male blade) and lower blade (female blade). The slitting speed, engaging depth, peripheral speed ratio of the upper blade (male blade) and lower blade (female blade) (upper blade peripheral speed/lower blade peripheral speed), period of continuous use of slitting blade, and the like can be suitably selected.

### EXAMPLES

The present invention will be described in detail below based on examples. However, the present invention is not limited to the examples. The term “parts” given in Examples are weight parts unless specifically stated otherwise.

### Examples 1 to 11 and Comparative Examples 1 to 13

Various starting materials were weighed out and mixed in a mixer to achieve the ratios indicated in Table 1 of the various components indicated in Table 1. The mixture was charged to a one-liter platinum crucible and high-frequency melted at the melting temperature indicated in Table 1. A Co-containing component, Zn-containing component, and Nb-containing component were added to the starting material mixtures in Examples 1 to 11 and Comparative Examples 1 to 11 and 13 so that portions of the Fe in the Fe₂O₃ were replaced with Co=0.5 at %, Zn=1.5 at %, and Nb=1 at %. Comparative Example 12 corresponds to Example 2 in Japanese Examined Patent Publication (KOKOKU) Heisei No. 5-12842, in which a 4.5 mole percent CoO component and a 4.5 mole percent TiO₂ component were added to the starting material mixture.

The melt was further heated while being stirred to a melt temperature of 1,400° C., at which time the melt outlet was heated and the melt was poured dropwise onto a pair of water-cooled rolls being rotated at the peripheral speed indicated in Table 2 at a drip rate of 4 to 6 g/s. The melt was then rapidly cooled by rolling at the pressure between rolls indicated in Table 2 to produce an amorphous material. The rolls employed were comprised of hard chrome plating with a thermal conductivity of about 90 W/m·K applied on a steel surface. Example 10 and Comparative Example 13 were identical to Example 1 with the exception that the cooling roll conditions were varied. Example 11 was identical to Example 8 with the exception that the cooling roll conditions were varied.

In Examples 1 to 11 and Comparative Examples 1 to 11 and 13, 300 g of the amorphous material obtained was charged to an electric furnace, the temperature was raised at 30° C./min to the crystallization temperature indicated in Table 1, and the temperature was maintained for 5 hours to induce crystallization of hexagonal ferrite. Next, the crystallized product including the hexagonal ferrite was coarsely pulverized in a mortar and charged to a 2,000 mL glass bottle to which 1,000 g of Zr beads 1 mm in diameter and 800 mL of a 1 weight percent concentration of acetic acid were added. The mixture was then dispersed for 3 hours in a paint shaker. Subsequently, the dispersion was separated from the beads and placed in a three-liter stainless steel beaker. The dispersion was processed for 3 hours at 100° C., precipitated using a centrifugal separator, and repeatedly decanted, washed, and dried, yielding hexagonal ferrite powders. In Comparative Example 12, crystallization was conducted according to the method of the above-cited publication by raising the temperature to 500° C. at 120° C./hour, maintaining that temperature for 6 hours, raising the temperature to 800° C. at 120° C./hour, maintaining that temperature for 8 hours, and then returning the temperature to room temperature at 120° C./hour.

The samples obtained in the above Examples and Comparative Examples were analyzed by X-ray diffraction to confirm that they were hexagonal ferrite (barium ferrite).

### Evaluation Methods

1. Average Plate Diameter, Coefficient of Variation in Particle Size Distribution

Following the above drying, the particles obtained were photographed by a transmission electron microscope. Five hundred of the particles were randomly extracted from the photo and the plate diameter thereof was averaged to obtain the average plate diameter. The standard deviation was calculated from 500 measurement values and divided by the average plate diameter to obtain the coefficient of variation in particle size distribution, which is shown in Table 1.

2. Coercivity Hc

Following the above drying, the coercivity of the particles obtained was measured at a magnetic field intensity of 15 kOe (approximately 1,194 kA/m) with a vibrating sample fluxmeter (made by Toei Industry Co., Ltd.). The results are given in Table 1.

3. Saturation Magnetization Level of Amorphous Material

A portion of the amorphous material prepared by the above-described method was collected and the saturation magnetization level thereof was measured at a magnetic field intensity of 15 k Oe (approximately 1,194 kA/m) with a vibrating sample fluxmeter (made by Toei Industry Co., Ltd.). The results are given in Table 1.

TABLE 1

| | | | | | | | Saturation |
|---|---|---|---|---|---|---|---|
| | Starting material composition | | | | | | magnetization level |
| | B₂O₃ | BaO | Fe₂O₃^{Note 1)} | SiO₂ % | SiO₂ | Melting | of amorphous material |
| | mol % | mol % | mol % | (relative to B₂O₃) | mol % | temp. ° C. | A · m²/kg |
| Comp. Ex. 1 | 21.7 | 29.8 | 48.5 | 0 | 0 | 1210 | 0.98 |
| Comp. Ex. 2 | 23.3 | 30.9 | 45.8 | 0 | 0 | 1200 | 0.65 |
| Ex. 1 | 24.3 | 31.7 | 44 | 0 | 0 | 1180 | 0.57 |
| Ex, 2 | 26.9 | 33.5 | 39.6 | 0 | 0 | 1160 | 0.42 |
| Ex. 3 | 26.4 | 33.1 | 40.5 | 0 | 0 | 1180 | 0.41 |
| Comp. Ex. 3 | 34.1 | 38.6 | 27.3 | 0 | 0 | 1080 | 0.20 |
| Comp. Ex. 4 | 38.4 | 41.7 | 19.8 | 0 | 0 | 1040 | 0.21 |
| Ex. 4 | 26.4 | 33.1 | 40.5 | 0 | 0 | 1180 | 0.41 |
| Ex. 5 | 26.4 | 33.1 | 40.5 | 0 | 0 | 1180 | 0.41 |
| Comp. Ex. 5 | 26.4 | 33.1 | 40.5 | 0 | 0 | 1180 | 0.41 |
| Comp. Ex. 6 | 28.4 | 34.6 | 37 | 0 | 0 | 1090 | 0.38 |
| Comp. Ex. 7 | 28.4 | 34.6 | 37 | 0 | 0 | 1090 | 0.38 |
| Comp. Ex. 8 | 26.4 | 33.1 | 40.5 | 0 | 0 | 1180 | 0.41 |
| Ex. 6 | 25.6 | 33.1 | 40.5 | 3 | 0.8 | 1160 | 0.35 |
| Ex. 7 | 25.1 | 33.1 | 40.5 | 5 | 1.3 | 1140 | 0.27 |
| Ex. 8 | 21.1 | 33.1 | 40.5 | 20 | 5.3 | 1130 | 0.21 |
| Comp. Ex. 9 | 21.1 | 33.1 | 40.5 | 20 | 5.3 | 1130 | 0.21 |
| Ex. 9 | 15.8 | 33.1 | 40.5 | 40 | 10.6 | 1120 | 0.23 |
| Comp. Ex. 10 | 14.7 | 35.3 | 35.4 | 50 | 14.7 | 1250 | 0.29 |
| Comp. Ex. 11 | 14.7 | 35.3 | 35.4 | 50 | 14.7 | 1250 | 0.29 |
| Comp. Ex. 12 | 17 | 35 | 29 | | 10 | 1100 | 0.32 |
| Ex. 10 | 24.3 | 31.7 | 44 | 0 | 0 | 1180 | 0.50 |
| Comp. Ex. 13 | 24.3 | 31.7 | 44 | 0 | 0 | 1180 | 0.65 |
| Ex. 11 | 21.1 | 33.1 | 40.5 | 20 | 5.3 | 1130 | 0.35 |

| | | | Coefficient of | | |
|---|---|---|---|---|---|
| | Crystallization | Average plate | variation in | | |
| | temp. | diameter of | particle size | Hc | |
| | ° C. | particles nm | distribution % | Unit: Oe | Unit: KA/m |
| Comp. Ex. 1 | 650 | 19 | 35 | 2750 | 219 |
| Comp. Ex. 2 | 650 | 20 | 35 | 2800 | 223 |
| Ex. 1 | 650 | 20 | 19 | 2980 | 237 |
| Ex, 2 | 650 | 21 | 23 | 3200 | 255 |
| Ex. 3 | 630 | 18 | 20 | 2860 | 228 |
| Comp. Ex. 3 | 600 | 23 | 34 | 3300 | 263 |
| Comp. Ex. 4 | 600 | 25 | 43 | 3360 | 268 |
| Ex. 4 | 660 | 21 | 19 | 3110 | 248 |
| Ex. 5 | 690 | 24 | 25 | 3380 | 269 |
| Comp. Ex. 5 | 750 | 36 | 33 | 4260 | 339 |
| Comp. Ex. 6 | 650 | 23 | 35 | 3250 | 259 |
| Comp. Ex. 7 | 620 | 20 | 34 | 3190 | 254 |
| Comp. Ex. 8 | 590 | 14 | 22 | 2260 | 180 |
| Ex. 6 | 650 | 20 | 23 | 3060 | 244 |
| Ex. 7 | 660 | 20 | 19 | 2850 | 227 |
| Ex. 8 | 660 | 19 | 18 | 3010 | 240 |
| Comp. Ex. 9 | 720 | 24 | 30 | 3170 | 252 |
| Ex. 9 | 660 | 18 | 16 | 2310 | 184 |
| Comp. Ex. 10 | 660 | 16 | 35 | 2170 | 173 |
| Comp. Ex. 11 | 750 | 25 | 37 | 3060 | 244 |
| Comp. Ex. 12 | 500→800 | 55 | 36 | 980 | 78 |
| Ex. 10 | 650 | 18 | 17 | 2870 | 229 |
| Comp. Ex. 13 | 650 | 23 | 34 | 3040 | 242 |
| Ex. 11 | 660 | 22 | 20 | 3100 | 247 |

^{Note 1)}
For Examples 1-10 and Comparative Examples 1-11, 13, total amount of Fe₂O₃ and replacement components.

TABLE 2

| | Roll peripheral speed | Pressure between rolls |
|---|---|---|
| | m/sec | KN/cm |
| Comp. Ex. 1 | 20 | 0.5 |
| Comp. Ex. 2 | 20 | 0.5 |
| Ex. 1 | 20 | 0.5 |
| Ex. 2 | 20 | 0.5 |
| Ex. 3 | 20 | 0.5 |
| Comp. Ex. 3 | 20 | 0.5 |
| Comp. Ex. 4 | 20 | 0.5 |
| Ex. 4 | 20 | 0.5 |
| Ex. 5 | 20 | 0.5 |
| Comp. Ex. 5 | 20 | 0.5 |
| Comp. Ex. 6 | 20 | 0.5 |
| Comp. Ex. 7 | 20 | 0.5 |
| Comp. Ex. 8 | 20 | 0.5 |
| Ex. 6 | 20 | 0.5 |
| Ex. 7 | 20 | 0.5 |
| Ex. 8 | 20 | 0.5 |
| Comp. Ex. 9 | 20 | 0.5 |
| Ex. 9 | 20 | 0.5 |
| Comp. Ex. 10 | 20 | 0.5 |
| Comp. Ex. 11 | 20 | 0.5 |
| Comp. Ex. 12 | 20 | 0.5 |
| Ex. 10 | 30 | 1.0 |
| Comp. Ex. 13 | 5 | 0.2 |
| Ex. 11 | 5 | 0.2 |

From the results in Table 1, it can be understood that the hexagonal ferrite magnetic powders of Examples 1 to 11 exhibited coercivity levels suited to magnetic recording and markedly improved particle size distributions.

### Examples 12 to 15, Comparative Examples 14 and 15

### Preparation of Coating Liquid for Magnetic Tape

1. Magnetic Layer Coating Liquid

| | | |
|---|---|---|
| Barium ferrite magnetic powder: See Table 3 | 100 | parts |
| Polyurethane resin | 12 | parts |
| Weight average molecular weight: 10,000 | | |
| Sulfonic functional group: 0.5 meq/g | | |
| Diamond microparticle | 2 | parts |
| (Average particle diameter: 0.10 μm) | | |
| Carbon black (Particle size: 0.015 μm) | 0.5 | part |
| #55 (made by Asahi Carbon Co., Ltd.) | | |
| Stearic acid | 0.5 | part |
| Butyl stearate | 2 | parts |
| Methyl ethyl ketone | 180 | parts |
| Cyclohexanone | 100 | parts |

2. Nonmagnetic Layer Coating Liquid

| | | |
|---|---|---|
| Nonmagnetic powder α-iron oxide | 100 | parts |
| Average primary particle diameter: 0.09 μm | | |
| Specific surface area by BET method: 50 m²/g | | |
| pH: 7 | | |
| DBP oil absorption capacity: 27 to 38 g/100 g | | |
| Surface treatment agent: Al₂O₃, 8 weight percent | | |
| Carbon black | 25 | parts |
| CONDUCTEX SC-U | | |
| (made by Columbia Carbon Co., Ltd.) | | |
| Vinyl chloride copolymer | 13 | parts |
| MR 104 (made by Nippon Zeon Co., Ltd.) | | |
| Polyurethane resin | 5 | parts |
| UR 8200 (made by Toyobo Co., Ltd.) | | |
| Phenyl phosphonic acid | 3.5 | parts |
| Butyl stearate | 1 | part |
| Stearic acid | 2 | parts |
| Methyl ethyl ketone | 205 | parts |
| Cyclohexanone | 135 | parts |

<Preparation of Magnetic Tape>

The various components of each of the above coating liquids were kneaded in a kneader. The liquid was pumped into a horizontal sand mill packed with a 65 percent volume (relative to the dispersion element) of zirconia beads 1.0 mm in diameter, and the mixture was dispersed for 120 hours at 2,000 rpm (the time essentially present in the dispersion element). To the dispersion obtained were added 6.5 parts of polyisocyanate in the case of the nonmagnetic layer coating liquid, and 7 parts of methyl ethyl ketone. The mixture was filtered with a filter having an average pore diameter of 1 micrometer to prepare coating liquids for forming a nonmagnetic layer and a magnetic layer.

The nonmagnetic layer coating liquid obtained was coated to a 52 micrometer polyethylene naphthalate base and dried to a dry thickness of 1.5 micrometers, after which a magnetic layer was successively coated in a multilayer coating to yield the thickness indicated in Table 2. Following drying, the coatings were processed with a seven-stage calender at a temperature of 90° C. and a linear pressure of 300 kg/cm. The product was slit to ¼ inch width and surface abrasion treated to obtain magnetic tape.

### Evaluation Methods

1. Magnetic Characteristics (Hc, Squareness (SQ), Switching-Field Distribution (SFD))

The Hc, SQ and SFD were measured at a magnetic field intensity of 15 KOe (approximately 1,194 kA/m) with a vibrating sample fluxmeter (made by Toei Industry Co., Ltd.).

2. Output, SNR

Measurement was conducted with a recording head (MIG, 0.15 micrometer gap, 1.8 T) and a reproduction GMR head mounted on a drum tester. A signal was recorded at a 400 Kbpi linear recording density and 16 KTPI track density (6.4 Gbpsi surface recording density), after which the output and SNR were measured.

TABLE 3

| | Magnetic | Magnetic layer | Hc | | | | Output | SNR |
|---|---|---|---|---|---|---|---|---|
| | powder No. | thickness nm | Unit: Oe | Unit: KA/m | SQ | SFD | dB | dB |
| Ex. 12 | Ex. 1 | 100 | 2140 | 170 | 0.46 | 0.6 | 0 | 0 |
| Comp. Ex. 14 | Comp. Ex. 7 | 100 | 2110 | 168 | 0.45 | 1.1 | −1.8 | −1.5 |
| Ex. 13 | Ex. 8 | 100 | 2090 | 166 | 0.46 | 0.4 | 0.2 | 0.2 |
| Ex. 14 | Ex. 1 | 60 | 1810 | 144 | 0.39 | 0.9 | 1.2 | 1.5 |
| Comp. Ex. 15 | Comp. Ex. 7 | 60 | 1780 | 142 | 0.4 | 1.7 | −1 | −0.5 |
| Ex. 15 | Ex. 8 | 60 | 1790 | 143 | 0.4 | 0.7 | 1.6 | 2.1 |

From the results in Table 3, it can be understood that the magnetic tapes of Examples employing hexagonal ferrite magnetic powders prepared in Examples exhibited better output and SNRs than the magnetic tapes of Comparative Examples, and that even better magnetic characteristics were exhibited when the magnetic layer thickness was reduced. The media of Examples had lower switching-field distributions (SFD), indicating Hc distributions, than the media of Comparative Examples. This was the result of using hexagonal ferrite magnetic powders of sharp particle size distribution. The lower the SFD, the lower the peak shift and the sharper the reversal of magnetization were. This was suited to high-density digital magnetic recording. In a comparison of Examples in which identical magnetic powder was employed, the thinner the magnetic layer was, the better the output and SNR were. This was attributed to enhancement of effects, due to reduction in the component of extremely small particles that did not contribute to recording and reduction in the component of extremely coarse particles thought to affect noise, as the total number of magnetic particles decreased, as set forth above.

The present invention can provide a magnetic recording medium for high-density recording with excellent magnetic characteristics.

Although the present invention has been described in considerable detail with regard to certain versions thereof, other versions are possible, and alterations, permutations and equivalents of the version shown will become apparent to those skilled in the art upon a reading of the specification and study of the drawings. Also, the various features of the versions herein can be combined in various ways to provide additional versions of the present invention. Furthermore, certain terminology has been used for the purposes of descriptive clarity, and not to limit the present invention. Therefore, any appended claims should not be limited to the description of the preferred versions contained herein and should include all such alterations, permutations, and equivalents as fall within the true spirit and scope of the present invention.

Having now fully described this invention, it will be understood to those of ordinary skill in the art that the methods of the present invention can be carried out with a wide and equivalent range of conditions, formulations, and other parameters without departing from the scope of the invention or any embodiments thereof.

All patents and publications cited herein are hereby fully incorporated by reference in their entirety. The citation of any publication is for its disclosure prior to the filing date and should not be construed as an admission that such publication is prior art or that the present invention is not entitled to antedate such publication by virtue of prior invention.

What is claimed is:

1. A method of manufacturing a hexagonal ferrite magnetic powder comprising:
preparing a melt by melting a starting material mixture, wherein the starting material mixture comprises a hexagonal ferrite-forming component and a glass-forming component comprising a B₂O₃ component and a content of the B₂O₃ component in the starting material mixture ranges from 15 to 27 mole percent in terms of B₂O₃;
rapidly cooling the melt to obtain a solid having a saturation magnetization level of equal to or lower than 0.6 A·m²/kg; and
heating the solid to a temperature range of 600 to 690° C. and maintaining the solid within the temperature range to precipitate a hexagonal ferrite magnetic powder having an average plate diameter ranging from 15 to 25 nm.

2. The method of manufacturing a hexagonal ferrite magnetic powder according to claim 1, wherein the starting material mixture comprises a glass-forming component other than the B₂O₃ component.

3. The method of manufacturing a hexagonal ferrite magnetic powder according to claim 2, wherein the glass-forming component other than the B₂O₃ component comprises a SiO₂ component.

4. The method of manufacturing a hexagonal ferrite magnetic powder according to claim 2, wherein a content of the glass-forming component other than the B₂O₃ component in the starting material mixture ranges from 5 to 40 mole percent on the basis of oxide relative to the content of the B₂O₃ component in terms of B₂O₃.

5. The method of manufacturing a hexagonal ferrite magnetic powder according to claim 1, wherein the hexagonal ferrite magnetic powder is a barium ferrite magnetic powder.

6. The method of manufacturing a hexagonal ferrite magnetic powder according to claim 1, wherein the hexagonal ferrite magnetic powder has a coefficient of variation in particle diameter distribution of equal to or lower than 25 percent.

7. A magnetic recording medium comprising a magnetic layer on a nonmagnetic support, wherein the magnetic layer comprises a hexagonal ferrite magnetic powder obtained by the method according to claim 1 and a binder.

8. The magnetic recording medium according to claim 7, wherein the magnetic layer has a thickness of equal to or less than 80 nm.

9. A method of manufacturing a magnetic recording medium comprising:
manufacturing a hexagonal ferrite magnetic power by the method according to claim 1; and
forming a magnetic layer with the manufactured hexagonal ferrite magnetic power.

10. The method of manufacturing a magnetic recording medium according to claim 9, wherein the magnetic layer has a thickness of equal to or less than 80 nm.
